(19) United States
(12) Patent Application Publication
(10) Pub. No.: US 2018/0120851 A1
(43) Pub. Date: May 3, 2018

(54) APPARATUS AND METHOD FOR SCANNING PARKING SLOT

(71) Applicant: HYUNDAI MOTOR COMPANY, Seoul (KR)

(72) Inventors: Hyeon Sik SHIN, Anyang-si (KR); Young Jun SON, Gunpo-si (KR); Eun Ho SEO, Gwangmyeong-si (KR); Kwang Hyun PARK, Suwon-si (KR); Yang Shin KIM, Incheon (KR)

(21) Appl. No.: 15/581,098

(22) Filed: Apr. 28, 2017

(30) Foreign Application Priority Data
Oct. 31, 2016 (KR) 10-2016-0143071

(51) Int. Cl. G05D 1/02; B60W 30/06; G01S 17/93

(52) U.S. Cl. CPC G05D 1/024; G01S 17/936; B60W 30/06

(57) ABSTRACT

An apparatus for scanning a parking slot includes: a parking slot detecting processor configured to: extract line segments from obstructions around a vehicle using a light detection and ranging (LIDAR) sensor and detect a parking slot candidate by comparing a distance between the line segments extracted from the obstructions with width or length information of the vehicle; a posture information calculating processor configured to calculate posture information of the vehicle with respect to the detected parking slot candidate; a path generating processor configured to generate a parking path for autonomous parking in the detected parking slot candidate with respect to the posture information of the vehicle; and a determining processor configured to determine whether it is possible to park in the corresponding parking slot candidate based on the generated parking path and determine the parking slot candidate as a target parking slot.

### CROSS-REFERENCE TO RELATED APPLICATION

This application is based on and claims the benefit of priority to Korean Patent Application No. 10-2016-0143071, filed on Oct. 31, 2016, in the Korean Intellectual Property Office, the disclosure of which is incorporated herein in its entirety by reference.

### TECHNICAL FIELD

The present disclosure relates to apparatuses and methods for scanning parking slots.

### BACKGROUND

An autonomous driving vehicle may detect an empty parking slot using an ultrasonic sensor or an around view monitoring (AVM) system.

However, in case of using the ultrasonic sensor, there is a limitation in a distance for scanning a parking slot. It is possible to determine whether there is a vehicle using characteristics of ultrasonic waves, but it is difficult to accurately measure a parking slot using only ultrasonic waves. Further, in case of using the ultrasonic sensor, only after the autonomous driving vehicle passes a parked vehicle, it may scan a parking slot.

In addition, if the autonomous driving vehicle detects an empty parking slot using the AVM system, it should recognize a parking slot line. Thus, it is difficult to detect an empty parking slot in a space where there is no parking slot line.

### SUMMARY

The present disclosure has been made to solve the above-mentioned problems occurring in the prior art while advantages achieved by the prior art are maintained intact.

An aspect of the present disclosure provides an apparatus and method for scanning a parking slot to detect the parking slot using a light detection and ranging (LIDAR) sensor used in an autonomous driving vehicle without an ultrasonic sensor in an autonomous parking system.

The technical problems to be solved by the present disclosure are not limited to the aforementioned problems, and any other technical problems not mentioned herein will be clearly understood from the following description by those skilled in the art to which the present disclosure pertains.

According to an exemplary embodiment of the present disclosure, an apparatus may include: a parking slot detecting processor configured to extract line segments from obstructions around a vehicle using a light detection and ranging (LIDAR) sensor and detect a parking slot candidate by comparing a distance between the line segments extracted from the obstructions with width or length information of the vehicle; a posture information calculating processor configured to calculate posture information of the vehicle with respect to the detected parking slot candidate; a path generating processor configured to generate a parking path for autonomous parking in the detected parking slot candidate with respect to the posture information of the vehicle; and a determining processor configured to determine whether it is possible to park in the corresponding parking slot candidate based on the generated parking path and determine the parking slot candidate as a target parking slot.

According to another exemplary embodiment of the present disclosure, a method may include: extracting, by a parking slot detecting processor, line segments from obstructions around a vehicle using a light detection and ranging (LIDAR) sensor and detecting a parking slot candidate by comparing a distance between the line segments extracted from the obstructions with width or length information of the vehicle; calculating, by a posture information calculating processor, posture information of the vehicle with respect to the detected parking slot candidate; generating, by a path generating processor, a parking path for autonomous parking in the detected parking slot candidate with respect to the posture information of the vehicle; and determining, by a determining processor, whether it is possible to park in the corresponding parking slot candidate based on the generated parking path and determining the parking slot candidate as a target parking slot.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a vehicle to which a parking slot scanning apparatus is applied, according to an embodiment of the present disclosure;

FIG. 2 is a block diagram illustrating a configuration of a parking slot scanning apparatus according to an embodiment of the present disclosure;

FIGS. 3A, 3B, 3C, 3D, 4, and 5 are drawings illustrating parking slot scanning operations in a parking slot scanning apparatus according to an embodiment of the present disclosure;

FIG. 6 is a flowchart illustrating a parking slot scanning method according to an embodiment of the present disclosure; and

FIG. 7 is a block diagram illustrating a configuration of a computing system to which a parking slot scanning apparatus is applied, according to an embodiment of the present disclosure.

### DETAILED DESCRIPTION

Hereinafter, exemplary embodiments of the present disclosure will be described in detail with reference to the accompanying drawings. In the drawings, the same reference numbers will be used throughout to designate the same or equivalent elements. In addition, a detailed description of well-known features or functions will be ruled out in order not to unnecessarily obscure the gist of the present disclosure.

In describing elements of exemplary embodiments of the present disclosure, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

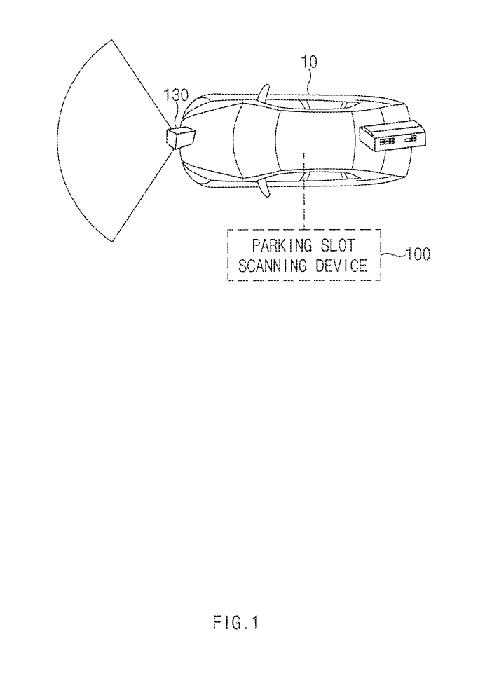

FIG. 1 is a drawing illustrating a vehicle to which a parking slot scanning apparatus is applied, according to an embodiment of the present disclosure.

Referring to FIG. 1, a parking slot scanning apparatus 100 according to an embodiment of the present disclosure may scan an obstruction such as a vehicle, a pillar, and a wall around a vehicle 10 using a light detection and ranging (LIDAR) sensor 130 installed in front of the vehicle 10 and may scan an empty parking slot using the scanned vehicle, pillar, and wall.

The parking slot scanning apparatus 100 according to an embodiment of the present disclosure may be implemented in the vehicle 10. In this case, the parking slot scanning apparatus 100 may be integrated with control units in the vehicle 10. Alternatively, the parking slot scanning apparatus 100 may be implemented to be independent of the control units in the vehicle 10 and may connect with the control units of the vehicle 10 by a separate connection means. Herein, the parking slot scanning apparatus 100 may operate in conjunction with an engine and motor of the vehicle 10 and may operate in conjunction with a control unit which controls an operation of the engine or motor. Also, the parking slot scanning apparatus 100 may operate in conjunction with an autonomous parking system.

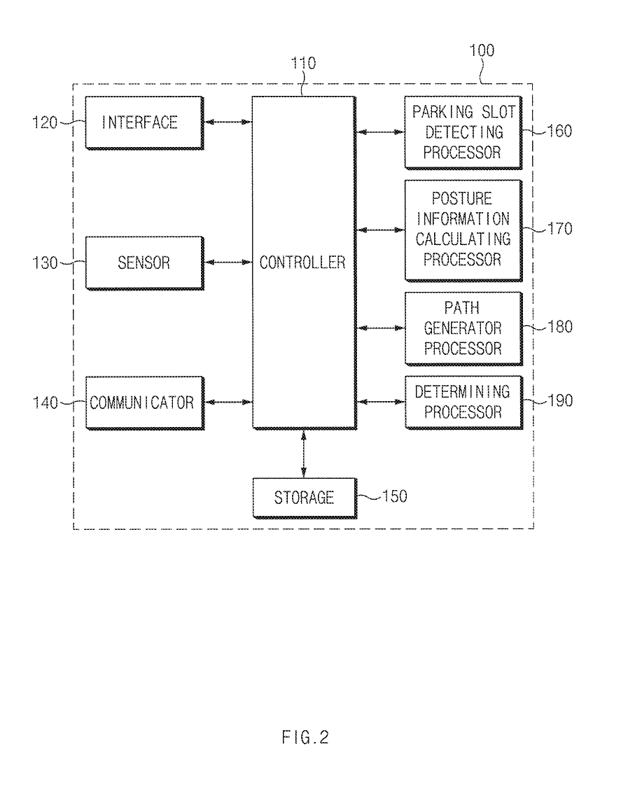

Detailed components of the parking slot scanning apparatus 100 will be described in detail with reference to FIG. 2.

FIG. 2 is a block diagram illustrating a configuration of a parking slot scanning apparatus according to an embodiment of the present disclosure.

Referring to FIG. 2, the parking slot scanning apparatus 100 may include a controller 110, an interface 120, a sensor 130, a communicator 140, a storage 150, a parking slot detector 160, a posture information calculating processor 170, a path generator 180, and a determining processor 190. Herein, the controller 110 may process a signal transmitted between components of the parking slot scanning apparatus 100.

The interface 120 may include an input means for receiving a control instruction from a driver of a vehicle and an output means for outputting an operation state, an operation result, and the like of the parking slot scanning apparatus 100.

Herein, the input means may correspond to a key button and may correspond to a mouse, a joystick, a jog shuttle, a stylus pen, and the like. The input means may correspond to a soft key implemented on a display of the vehicle.

The output means may include the display and may further include a voice output means such as a speaker. In this case, if a touch sensor such as a touch film, a touch sheet, or a touch pad is installed in the display, the display may operate as a touch screen and may be implemented in the form of integrating the input means with the output means.

The display may include at least one ofa liquid crystal display (LCD), a thin film transistor-LCD (TFT-LCD), an organic light-emitting diode (OLED), a flexible display, a field emission display (FED), and a three-dimensional (3D) display.

The sensor 130 may detect an obstruction located around the vehicle, for example, a vehicle, a pillar, a wall surface, or the like around the vehicle and may include a LIDAR sensor which measures a distance between the vehicle and the corresponding obstruction. The LIDAR sensor may periodically scan the periphery of the vehicle in a parking lot and may store the scanned data in the storage 150.

The information scanned by the LIDAR sensor may be data in the form of a point cloud. The parking slot scanning apparatus 100 may scan an obstruction using information of a line segment formed by a plurality of points among point clouds periodically stored in the storage 150 and may scan an empty parking slot.

The communicator 140 may include a communication module for supporting a communication interface with electronics and/or control units mounted on the vehicle. For example, the communication module may receive data scanned by the LIDAR sensor installed in the vehicle. Herein, the communication module may include a module for supporting vehicle network communication such as controller area network (CAN) communication, local interconnect network (LIN) communication, and flex-ray communication.

Further, the communication module may include a module for wireless Internet access or a module for short range communication. Herein, wireless Internet technology may include wireless local area network (WLAN), wireless broadband (Wibro), wireless-fidelity (Wi-Fi), a world interoperability for microwave access (Wimax), and the like. Short range communication technology may include Bluetooth, ZigBee, ultra wideband (UWB), radio frequency identification (RFID), infrared data association (IrDA), and the like.

The storage 150 may store data and/or an algorithm necessary for operating the parking slot scanning apparatus 100. For example, the storage 150 may store data scanned by the LIDAR sensor and may store a setting value and/or an algorithm for performing each operation in each of the parking slot detector 160, the posture information calculating processor 170, the path generator 180 and/or the determining processor 190.

Herein, the storage 150 may include storage media, such as a random access memory (RAM), a static RAM (SRAM), a read-only memory (ROM), a programmable ROM (PROM), and an electrically erasable PROM (EEPROM), on a computer readable medium containing executable program instructions executed by the controller 110.

The parking slot detector 160 may scan a parking slot based on data scanned by the LIDAR sensor.

Herein, the parking slot detector 160 may cluster a point cloud scanned by the LIDAR sensor and may extract line segment information from the clustered result. The line segment information extracted by the parking slot detector 160 may include information about attributes such as a length and variance of a corresponding line segment.

In this case, the parking slot detector 160 may detect a parking slot candidate using the attributes information of the extracted line segment information. For example, variance of a line segment detected by a pillar and a wall surface around the vehicle may have a similar value to variance detected by the LIDAR sensor. In contrast, since variance detected by the appearance of the vehicle has a curvature value, if the corresponding line segment is approximated as a straight line, variance of the approximated line segment may have a larger value than that detected by the LIDAR sensor.

Thus, the parking slot detector 160 may distinguish a pillar and/or a wall surface from the vehicle with respect to the length and variance of the line segment.

In the same manner, the parking slot detector 160 may detect one or more parking slot candidates using a relationship between line segment information detected by an empty space between a vehicle and another vehicle, between the vehicle and a pillar, between the vehicle and a wall surface, between the pillar and the wall surface.

The various embodiments disclosed herein, including embodiments of the parking slot scanning apparatus 100 and/or elements thereof, can be implemented using one or more processors coupled to a memory (or other non-transitory machine readable recording medium) storing computer-executable instructions for causing the processor(s) to perform the functions described above including the functions described in relation to the interface 120, the sensor 130, the communicator 140, the storage 150, the parking slot detecting processor 160, the posture information calculating processor 170, the path generating processor 180, and the determining processor 190 via the controller 110. The recording medium may be implemented in a non-transitory computer-readable recording medium.

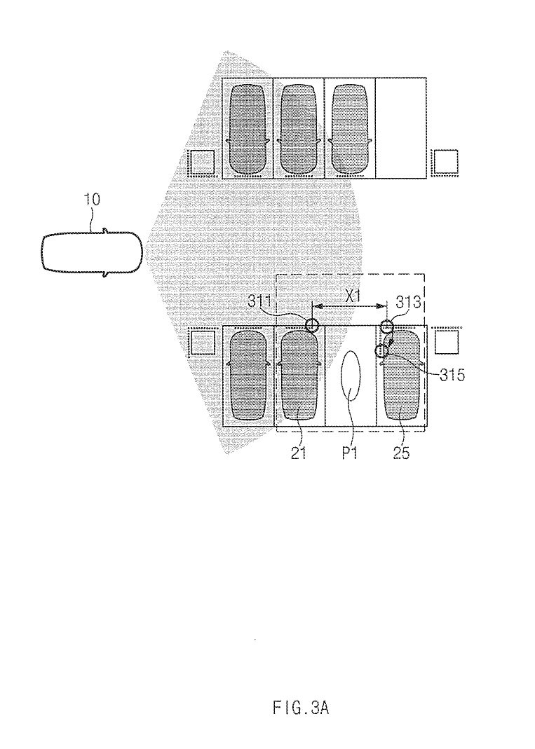

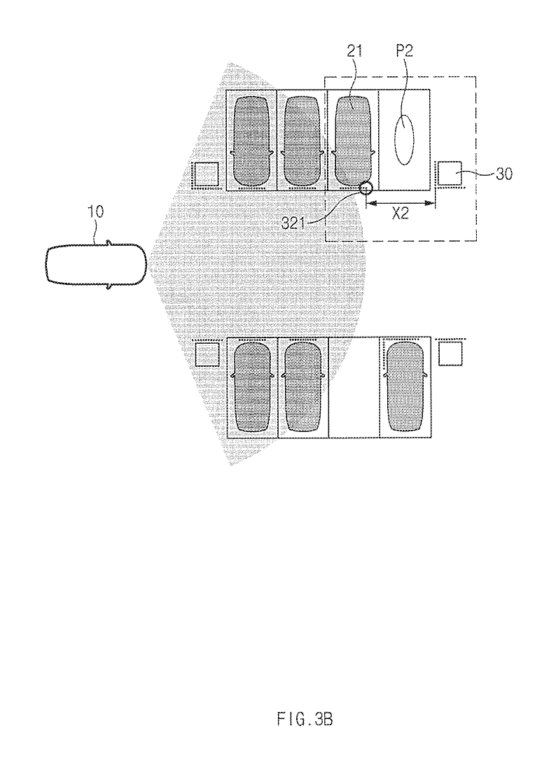

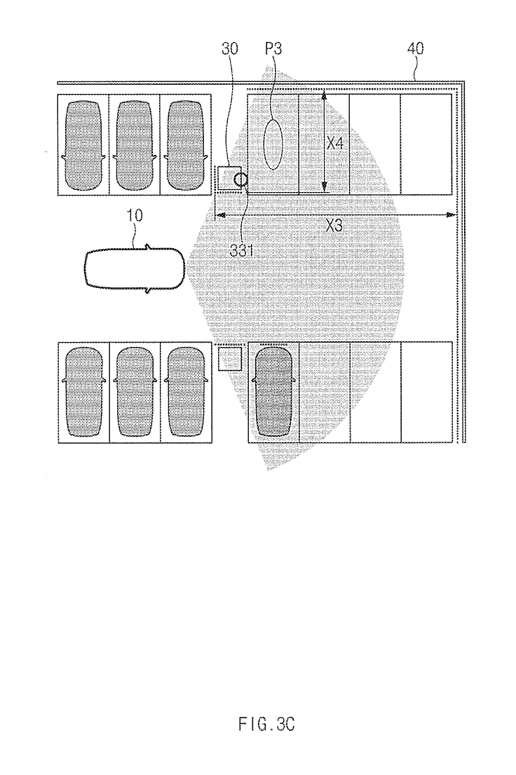

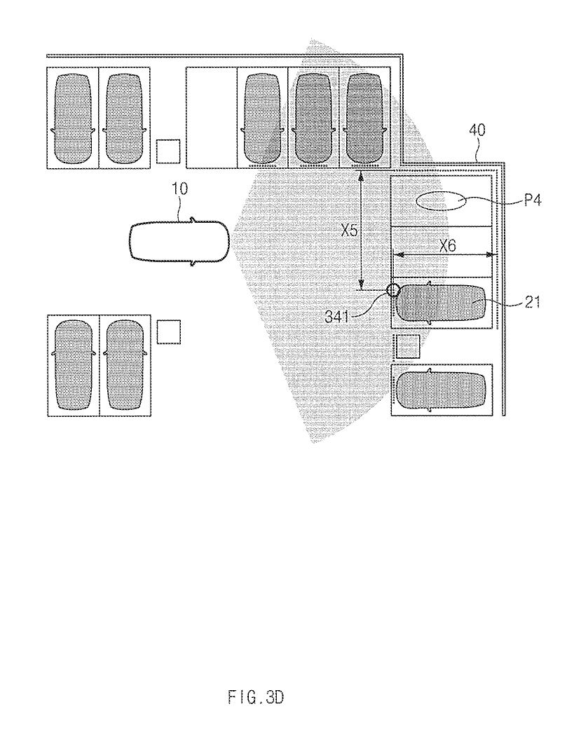

An embodiment of detecting a parking slot candidate will be described with reference to FIGS. 3A to 3D.

FIG. 3A illustrates an embodiment of detecting a parking slot candidate between a vehicle and another vehicle. Referring to FIG. 3A, a parking slot detector 160 of FIG. 2 may determine whether a direction of a line segment extracted from a first parked vehicle 21 is identical to a direction of a line segment extracted from a second parked vehicle 25 adjacent to the first parked vehicle 21. Herein, the parking slot detector 160 may verify a distance X1 between end points 311 and 313 located between the two line segments adjacent to each other. When the distance X between the end points 311 and 313 located between the two line segments adjacent to each other is greater than or equal to a multiple of a width or length of the vehicle 10, the parking slot detector 160 may detect a corresponding parking slot P1 as a parking slot candidate.

When detecting a parking slot candidate between vehicles while the vehicle 10 moves, the parking slot detector 160 may recognize a side of the vehicle as a line segment. In this case, the parking slot detector 160 may verify orthogonality to the most adjacent line segment and may detect a parking slot candidate using a distance between an end point 315 of the detected side line segment and the adjacent end point 311 of a subsequent line segment.

Herein, the parking slot candidate may include a coordinate of a central point of a parking slot and direction information. In this case, the central point of the parking slot may be reflected in consideration of the width or length of the vehicle 10 with respect to a line segment perpendicular to a moving direction of the vehicle 10 among line segments extracted from the first parked vehicle 21 or the second parked vehicle 25.

FIG. 3B illustrates an embodiment of detecting a parking slot candidate between a vehicle and a pillar. Referring to FIG. 3B, a parking slot detector 160 of FIG. 2 may determine whether a direction of a line segment extracted from a first parked vehicle 21 is identical to a direction of a line segment extracted from a pillar 30 adjacent to the first parked vehicle 21. Herein, the parking slot detector 160 may verify a distance X2 between end points 321 and 325 located between the two line segments adjacent to each other. If the distance X2 between the end points 321 and 325 located between the two line segments adjacent to each other is greater than or equal to a multiple of a width or length of the vehicle 10, the parking slot detector 160 may detect a corresponding parking slot P2 as a parking slot candidate.

Herein, the parking slot candidate may include a coordinate of a central point of a parking slot and direction information. In this case, the central point of the parking slot may be reflected in consideration of the width or length of the vehicle 10 with respect to a line segment perpendicular to a moving direction of the vehicle 10 among line segments extracted from the pillar 30.

FIG. 3C illustrates an embodiment of detecting a parking slot candidate between a pillar and a wall surface. Referring to FIG. 3C, a parking slot detector 160 of FIG. 2 may determine a parking slot using a distance between a line segment detected from a pillar 30 and a line segment detected from a wall surface 40. Herein, two line segments may be detected from each of the pillar 30 and the wall surface 40. Thus, if detecting one or two line segments from each of the pillar 30 and the wall surface 40, the parking slot detector 160 may calculate distances X3 and X3 between line segments, directions of which are identical to each other.

In this case, the parking slot detector 160 may compare the distance X4 between line segments identical to a moving direction of the vehicle 10 with a width and/or length of the vehicle 10. If the distance X4 is greater than or equal to a multiple of the width or length of the vehicle 10, the parking slot detector 160 may detect a corresponding parking slot P3 as a parking slot candidate.

Herein, the parking slot candidate may include a coordinate of a central point of a parking slot and direction information. In this case, the parking slot detector 160 may generate a virtual line segment 331 perpendicular to a moving direction of the vehicle 10 in the direction of the parking slot P3 with reference to the pillar 30. The central point of the parking slot may be reflected in consideration of the width or length of the vehicle 10 with respect to the virtual line segment 331.

FIG. 3D illustrates an embodiment of detecting a parking slot candidate between a vehicle and a pillar. Referring to FIG. 3D, a parking slot detector 160 of FIG. 2 may determine a parking slot using a distance between a line segment extracted from a first parked vehicle 21 and a line segment extracted from a wall surface 40 adjacent to the first parked vehicle 21.

Herein, two line segments may be detected from the wall surface 40. Thus, the parking slot detector 160 may calculate distances X5 and X6 between a point 341 close to the wall surface 40 on the line segment extracted from the first parked vehicle 21 and a line segment extracted from the wall surface 40.

In this case, the parking slot detector 160 may compare the calculated distances X5 and X6 with a width and/or length of the vehicle 10. If the distances X5 and X6 are greater than or equal to a multiple of the width or length of the vehicle 10, the parking slot detector 160 may detect a corresponding parking slot P4 as a parking slot candidate.

Herein, the parking slot candidate may include a coordinate of a central point of a parking slot and direction information. In this case, the central point of the parking slot may be reflected in consideration of the width or length of the vehicle 10 with respect to the line segment extracted from the wall surface 40.

If detecting a plurality of parking slot candidates, the parking slot detector 160 may form a group of the parking slot candidates.

If the result scanned by a LIDAR sensor is input again after the parking slot candidate is detected, the parking slot detector 160 may detect a line segment again based on the input scanned result, may determine whether the same parking slot candidate as the previously detected parking slot candidate is detected, and may track a parking slot candidate. Further, when detecting a new parking slot candidate, the parking slot detector 160 may add the detected new parking slot to the group of the parking slot candidates.

A posture information calculating processor 170 of FIG. 2 may arrange the parking slot candidates detected by the parking slot detector 160 in an order of distances close to the vehicle 10. The posture information calculating processor 170 may calculate posture information of the vehicle 10 relative to a central point of one of the arranged parking slot candidates.

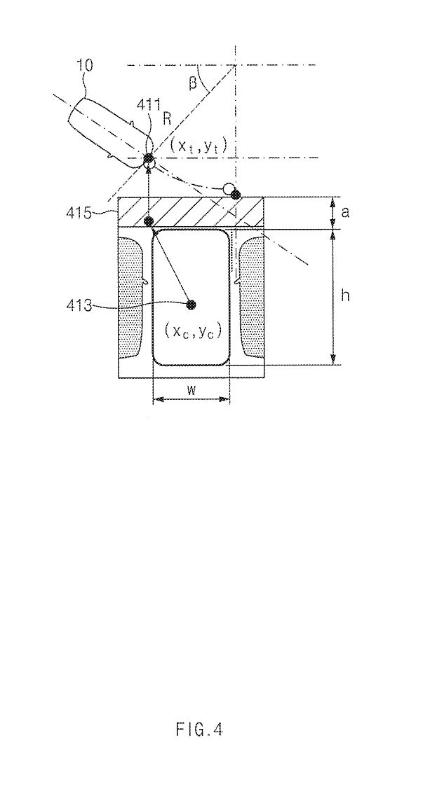

An embodiment of calculating posture information of the vehicle 10 will be described with reference to FIG. 4.

Referring to FIG. 4, it is assumed that a coordinate of a heading central point 411 of the vehicle 10 is (xt, yt), that a coordinate of a central point 413 of a parking slot candidate is (xc, yc), that a length of the parking slot candidate is h, and that a width of the parking slot candidate is w. It is assumed that an angle formed by a direction orthogonal to a heading direction of the vehicle 10 and a width direction of a parking slot is 3. The coordinate (xt, yt) of the heading central point 411 of the vehicle 10 may be calculated using Equations 1 and 2 below.

$$\begin{matrix}{x}_{t} = {x}_{c} - \frac{w}{2} & [ Equation 1 ] \\ {y}_{t} = {y}_{c} + \frac{h}{2} + a + R ( 1 - COS β ) & [ Equation 2 ]\end{matrix}$$

Herein, a posture information calculating processor 170 of FIG. 2 may generate a virtual region 415 for removing interference with a parked vehicle when the vehicle 10 is turned around the front of a parking slot. The virtual region 415 may be generated relative to a line segment detected at both sides of a parking slot candidate.

In this case, ‘a’ in Equation 2 denotes a width of the virtual region 415. β has a range of [−β, +β] with respect to a LIDAR coordinate system.

Thus, the posture information calculating processor 170 may calculate a posture of the vehicle 10 by calculating the coordinate (xt, yt) of the heading central point 411 of the vehicle 10 using Equations 1 and 2 above.

In the same manner, the posture information calculating processor 170 may calculate posture information about each of parking slot candidates arranged in an order of distances close to the vehicle 10.

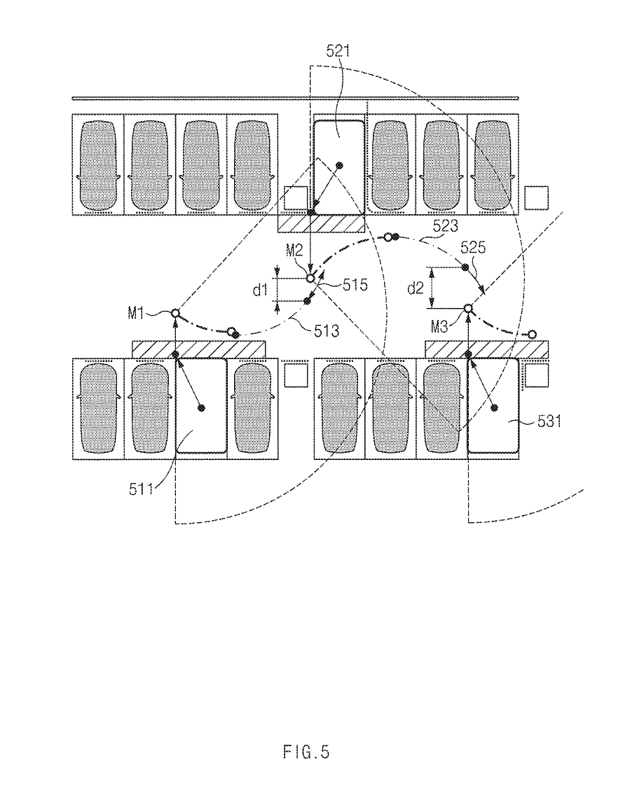

A path generator 180 of FIG. 2 may generate a parking path using the posture information of the vehicle 10, calculated by the posture information calculating processor 170, and information of the parking slot candidates. An embodiment of generating the parking path for each of the parking slot candidates will be described with reference to FIG. 5.

As shown in FIG. 5, the path generator 180 may generate a parking path in an order of the closest parking slot candidate among parking slot candidates arranged in an order of distances close to a vehicle.

The path generator 180 may generate a parking path based on a posture of the vehicle based on a heading central point M1 of the vehicle with respect to the closest first parking slot candidate 511 from the vehicle. A determining processor 190 of FIG. 2 may determine whether it is possible for the vehicle to park in the first parking slot candidate 511 based on the parking path generated relative to the first parking slot candidate 511.

If it is determined that it is possible for the vehicle to park in the first parking slot candidate 511, the path generator 180 may stop generating a parking path for each of a second parking slot candidate 521 and a third parking slot candidate 531.

If it is determined that it is impossible for the vehicle to park in the first parking slot candidate 511, the path generator 180 may generate a path deviation line 513. As the vehicle moves to the subsequent second parking slot candidate 521 along the generated path deviation line 513, the path generator 180 may generate a parking path. Herein, if a deviation path is generated using a Dubin method, a path a driver of the vehicle does not want may occur at a point dl due to a characteristic of a minimum turn circle. In this case, as shown in reference numeral 515, as the vehicle moves along a conventional turn circle to meet only a longitudinal coordinate of a target point, the path generator 180 may generate a parking path relative to the second parking slot candidate 521.

Thus, the determining processor 190 may determine whether it is possible to park in the second parking slot candidate 521 based on the parking path generated relative to the second parking slot candidate 521.

If it is determined that it is impossible to park in the second parking slot candidate 521, the path generator 180 may generate a return path which meets a longitudinal coordinate of a scan path point M2 for scanning the second parking slot candidate 521 to perform a subsequent operation. After the vehicle is backed up along the generated return path, as it moves to the subsequent third parking slot candidate 531 along a deviation path 523, the path generator 180 may generate a parking path relative to the third parking slot candidate 531.

If determining that it is possible to park in a parking slot candidate, the determining processor 190 may determine the corresponding parking slot candidate as a target parking slot. Thus, a controller 110 of FIG. 2 may set the target parking slot based on the result determined by the determiner 190, and may control a driving unit to perform autonomous parking in the set target parking slot or may send information about the target parking slot and information about a scan path to an autonomous parking system linked via a communicator 140 of FIG. 2.

A detailed description will be given of an operation of the parking slot scanning apparatus according to an embodiment of the present disclosure.

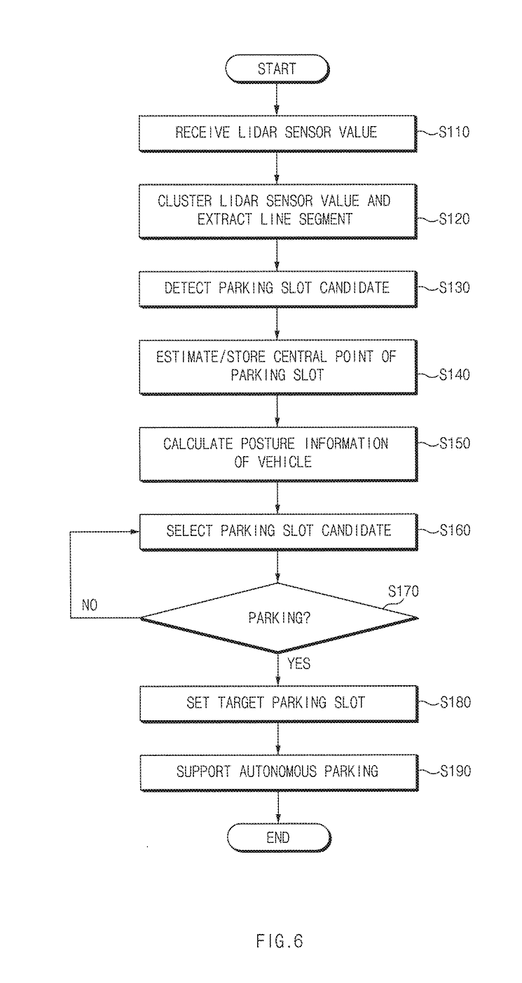

FIG. 6 is a flowchart illustrating a parking slot scanning method according to an embodiment of the present disclosure.

As shown in FIG. 6, a parking slot scanning apparatus 100 of FIG. 2 may scan the periphery of a vehicle using a LIDAR sensor of the vehicle. If receiving the LIDAR sensor value in the form of a point cloud in operation S110, in operation S120, the parking slot scanning apparatus 100 may cluster a LIDAR sensor value to extract line segment information.

In this case, in operation S130, the parking slot scanning apparatus 100 may detect a parking slot candidate using attributes information of the line segment information extracted in operation S120.

In operation S130, the parking slot scanning apparatus 100 may distinguish a vehicle, a pillar, and/or a wall surface with respect to information about attributes such as a length and variance of a line segment and may detect one or more parking slot candidates using a relationship between line segment information detected by an empty space between the vehicle and another vehicle, between the vehicle and the pillar, between the vehicle and the wall surface, and between the pillar and the wall surface.

Further, in operation S140, the parking slot scanning apparatus 100 may estimate a central point of a parking slot candidate based on a side line segment of the detected parking slot candidate, a width of the vehicle, and the like and may store information of the parking slot candidate including the estimated central point information and direction information in the storage 150 of FIG. 2.

Although not illustrated in FIG. 6, operations 110 to 140 may be repeatedly performed whenever a LIDAR sensor value is newly input.

In operation S150, the parking slot scanning apparatus 100 may calculate posture information of the vehicle relative to the central point of the parking slot candidate. A detailed embodiment for operation S150 refers to a description of FIG. 4.

If the calculation of the posture information of the vehicle is completed, in operation S160, the parking slot scanning apparatus 100 may select one of parking slot candidates and may generate a parking path using the posture information of the vehicle relative to the selected parking slot candidate. In this case, in operation S170, the parking slot scanning apparatus 100 may determine whether it is possible to park in the parking slot candidate selected in operation S160 based on the generated parking path. If determining that it is impossible to park in the parking slot candidate, in operation S170, the parking slot scanning apparatus 100 may select another parking slot candidate again.

Herein, the parking slot scanning apparatus 100 may arrange parking slot candidates in an order of distances close to the vehicle and may select a parking slot candidate in the order of the distances close to the vehicle.

When determining that it is possible to park in the parking slot candidate in operation S170, in operation S180, the parking slot scanning apparatus 100 may set the corresponding parking slot candidate to a target parking slot. In operation S190, the parking slot scanning apparatus 100 may support autonomous parking relative to the target parking slot set in operation S180.

The parking slot scanning apparatus 100 according to an embodiment of the present disclosure may be implemented in the form of an independent hardware device and may be drive in the form of being included in another hardware device such as a micro-processor or a general purpose computer system as at least one or more processors.

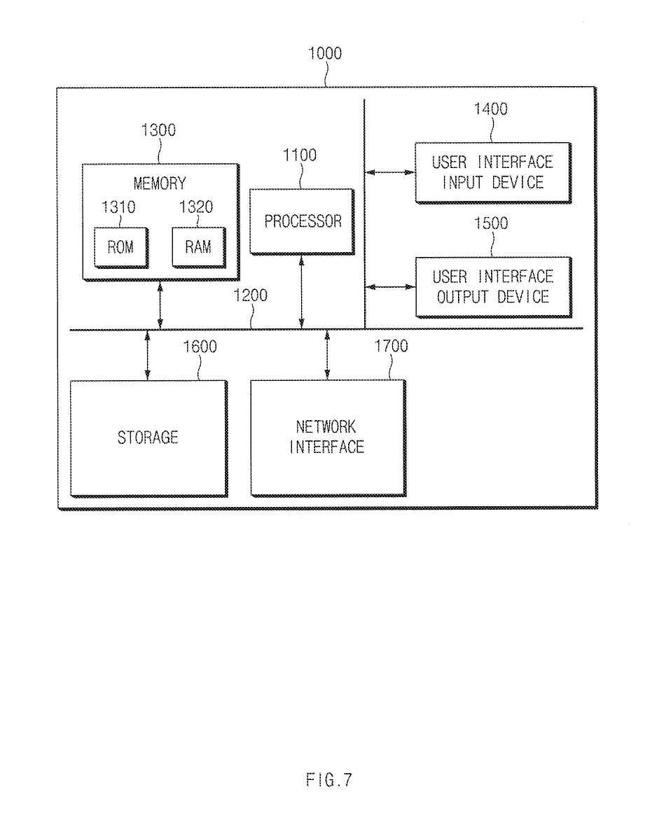

FIG. 7 is a block diagram illustrating a configuration of a computing system to which a parking slot scanning apparatus is applied, according to an embodiment of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the specification may be directly implemented with a hardware module, a software module, or combinations thereof, executed by the processor 1100. The software module may reside on a storage medium (e.g., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The integrated processor and storage medium may reside in an application specific integrated circuit (ASIC). The ASIC may reside in a user terminal. Alternatively, the integrated processor and storage medium may reside as a separate component of the user terminal.

According to various embodiments, the parking slot scanning apparatus 100 may detect a parking slot using a LIDAR sensor used in an autonomous driving vehicle without an ultrasonic sensor in an autonomous parking system. Also, the parking slot scanning apparatus 100 may avoid overlapping an ultrasonic scanning function by using the LIDAR sensor in the autonomous parking system.

While the present disclosure has been described with reference to exemplary embodiments, it will be apparent to those skilled in the art that various changes and modifications may be made without departing from the spirit and scope of the present disclosure.

Therefore, exemplary embodiments of the present disclosure are not limiting, but illustrative, and the spirit and scope of the present disclosure is not limited thereto. The spirit and scope and the present disclosure should be interpreted by the following claims, it should be interpreted that all technical ideas which are equivalent to the present disclosure are included in the spirit and scope of the present disclosure.

What is claimed is:

1. An apparatus for scanning a parking slot, the apparatus comprising:
a parking slot detecting processor configured to extract line segments from obstructions around a vehicle using a light detection and ranging (LIDAR) sensor and detect a parking slot candidate by comparing a distance between the line segments extracted from the obstructions with width or length information of the vehicle;
a posture information calculating processor configured to calculate posture information of the vehicle with respect to the detected parking slot candidate;
a path generating processor configured to generate a parking path for autonomous parking in the detected parking slot candidate with respect to the posture information of the vehicle; and
a determining processor configured to determine whether it is possible to park in the corresponding parking slot candidate based on the generated parking path and determine the parking slot candidate as a target parking slot.

2. The apparatus of claim 1, wherein the parking slot detecting processor is further configured to:
extract line segment information by clustering point cloud data of the LIDAR sensor, scanned from at least one of another vehicle, a pillar, and a wall surface of a parking lot.

3. The apparatus of claim 2, wherein the parking slot detecting processor is further configured to:
classify each of the obstructions as one of the other vehicle, the pillar, and the wall surface using length and variance information of the line segments extracted from each of the obstructions.

4. The apparatus of claim 3, wherein the parking slot detecting processor is further configured to:
detect an empty space between a first parked vehicle and a second parked vehicle as a first parking slot candidate, if a direction of a line segment extracted from the first parked vehicle is identical to a direction of a line segment extracted from the second parked vehicle adjacent to the first parked vehicle and if a distance between end points of the two line segments adjacent to each other is greater than or equal to a width or length of the vehicle.

5. The apparatus of claim 4, wherein the parking slot detecting processor is further configured to:
detect a central point of the first parking slot candidate using the width or length of the vehicle with respect to a line segment perpendicular to a moving direction of the vehicle among line segments extracted from the first parked vehicle or the second parked vehicle.

6. The apparatus of claim 3, wherein the parking slot detecting processor is further configured to:
detect an empty space between a first parked vehicle and the pillar as a second parking slot candidate, if a direction of a line segment extracted from the first parked vehicle is identical to a direction of a line segment extracted from the pillar adjacent to the first parked vehicle and if a distance between end points located between the two line segments adjacent to each other is a multiple of a width or length of the vehicle.

7. The apparatus of claim 6, wherein the parking slot detecting processor is further configured to:
detect a central point of the second parking slot candidate using the width or length of the vehicle with respect to a line segment perpendicular to a moving direction of the vehicle among line segments extracted from the pillar.

8. The apparatus of claim 3, wherein the parking slot detecting processor is further configured to:
detect an empty space between the pillar and the wall surface as a third parking slot candidate, if a direction of a line segment extracted from the pillar is identical to a direction of a line segment extracted from the wall surface adjacent to the pillar and if a distance between the two line segments adjacent to each other is a multiple of a width or length of the vehicle.

9. The apparatus of claim 8, wherein the parking slot detecting processor is further configured to:
generate a virtual line segment perpendicular to a moving direction of the vehicle in the direction of the third parking slot candidate with respect to the pillar; and
detect a central point of the third parking slot candidate using the width or length of the vehicle with respect to the virtual line segment.

10. The apparatus of claim 3, wherein the parking slot detecting processor is further configured to:
detect an empty space between a first parked vehicle and the wall surface as a fourth parking slot candidate, if a distance between an end point close to the wall surface adjacent to the first parked vehicle in a line segment extracted from the first parked vehicle and a line segment extracted from the wall surface is a multiple of a width or length of the vehicle.

11. The apparatus of claim 10, wherein the parking slot detecting processor is further configured to:
detect a central point of the fourth parking slot candidate using the width or length of the vehicle with respect to the line segment extracted from the wall surface.

12. The apparatus of claim 1, wherein the posture information calculating processor is further configured to:
calculate posture information of the vehicle using one or more of a coordinate of a central point of the parking slot candidate, a length of the parking slot candidate, a width of the parking slot candidate, and an angle formed by a width direction of the parking slot candidate and a direction perpendicular to a moving direction of the vehicle.

13. The apparatus of claim 12, wherein the posture information calculating processor is further configured to:
generate a virtual region for removing interference with a parked vehicle, if the vehicle is turned around in front of the parking slot candidate; and
calculate the posture information of the vehicle using width information of the virtual region.

14. The apparatus of claim 13, wherein the path generating processor is further configured to:
arrange one or more parking slot candidates in an order of distances close to the vehicle; and
generate a parking path in an order of the one or more parking slot candidates close to the vehicle.

15. The apparatus of claim 14, wherein the path generating processor is further configured to:
end generating the parking path, if it is determined that it is possible to park in a parking slot candidate selected among the one or more parking slot candidates;
select a subsequent parking slot candidate, if it is impossible to park in the parking slot candidate; and
generate a parking path for autonomous parking in the corresponding parking slot candidate.

16. The apparatus of claim 1, further comprising:
a controller configured to set the target parking slot and perform autonomous parking in the set target parking slot by controlling a driving unit of the vehicle.

17. The apparatus of claim 1, further comprising:
a communicator configured to send information about the target parking slot and information about a parking path to the target parking slot to an autonomous parking system.

18. A method for scanning a parking slot, the method comprising steps of:
extracting, by a parking slot detecting processor, line segments from obstructions around a vehicle using a light detection and ranging (LIDAR) sensor and detecting a parking slot candidate by comparing a distance between the line segments extracted from the obstructions with width or length information of the vehicle;
calculating, by a posture information calculating processor, posture information of the vehicle with respect to the detected parking slot candidate;
generating, by a path generating processor, a parking path for autonomous parking in the detected parking slot candidate with respect to the posture information of the vehicle; and
determining, by a determining processor, whether it is possible to park in the corresponding parking slot candidate based on the generated parking path and determining the parking slot candidate as a target parking slot.

19. The method of claim 18, wherein the step of detecting the parking slot candidate comprises:
extracting line segment information by clustering point cloud data of the LIDAR sensor, scanned from at least one of another vehicle, a pillar, and a wall surface of a parking lot; and
classifying each of the obstructions as one of the other vehicle, the pillar, and the wall surface using length and variance information of the line segment extracted from each of the obstructions.

20. The method of claim 18, wherein the step of generating the parking path comprises:
arranging one or more parking slot candidates in an order of distances close to the vehicle;
selecting one parking candidate in an order of the one or more parking slot candidates close to the vehicle;
ending generating the parking path, if it is determined that it is possible to park in the selected parking slot candidate;
selecting a subsequent parking slot candidate, if it is impossible to park in the selected parking slot candidate; and
generating a parking path for autonomous parking in the corresponding parking slot candidate.
